(19) United States
(12) Patent Application Publication
(10) Pub. No.: US 2012/0173385 A1
(43) Pub. Date: Jul. 5, 2012

(54) Method and System for a Cloud Based Online Commerce and Listing Service for Item Providers

(75) Inventors: Guangbin Fan, Santa Clara, CA (US); Jiafeng Zhu, San Ramon, CA (US); Keren Jin, Sunnyvale, CA (US)

(73) Assignee: FUTUREWEI TECHNOLOGIES, INC., Plano, TX (US)

(21) Appl. No.: 13/338,500

(22) Filed: Dec. 28, 2011

Related U.S. Application Data
(60) Provisional application No. 61/428,747, filed on Dec. 30, 2010.

(51) Int. Cl. G06Q 30/06

(52) U.S. Cl. 705/26.41; 705/27.1; 705/26.8

(57) ABSTRACT

A cloud based service system for providing an online commerce and listing service comprising a cloud component configured to support the online commerce and listing service for a plurality of item providers and communicate with a plurality of subscriber websites accessible by a plurality of online user devices, a repository coupled to the cloud component and configured to store information for a plurality of items provided by the item providers, and an agent component for websites who subscribe to the online commerce and listing service, wherein the agent component is configured to match and embed an item description and shopping information to content of at least one of the subscriber websites.

### CROSS-REFERENCE TO RELATED APPLICATIONS

The present application claims the benefit of U.S. Provisional Patent Application No. 61/428,747 filed Dec. 30, 2010 by Guangbin Fan et al. and entitled “Method and System for Cloud Mall Service Among Distributed Users,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The development and proliferation of mobile applications and digital content is rapidly evolving. Efforts are being made to allow the Internet to offer a convenient and effective venue for product stores and service providers to effectively distribute and market their products and services. Current e-commerce store owners have to set up websites or web stores, such as Apple store, Amazon, eBay, etc. The web stores require the owners to upload applications for running the stores and/or to open similar stores in multiple websites to obtain buyers from different user groups. On the other hand, the consumers have to search and compare similar goods from multiple websites to obtain a better deal. This is an inefficient process and may cause consumers to be less willing to visit or purchase from online stores.

### SUMMARY

In one embodiment, the disclosure includes a cloud based service system for providing an online commerce and listing service comprising a cloud component configured to support the online commerce and listing service for a plurality of item providers and communicate with a plurality of subscriber websites accessible by a plurality of online user devices, a repository coupled to the cloud component and configured to store information for a plurality of items provided by the item providers, and an agent component for websites who subscribe to the online commerce and listing service, wherein the agent component is configured to match and embed an item description and shopping information to content of at least one of the subscriber websites.

In another embodiment, the disclosure includes a network component for operating an online commerce and listing service comprising a receiver configured to receive a request from a website accessed on a device of a consumer for obtaining information about an embedded item on the website, a repository configured to store the information about the item from the item provider, a logic unit configured to fetch the information about the embedded item on the website from the repository, and a transmitter configured to send the information about the embedded item to the website, wherein the item provider is different from the website' owner and from the online commerce and listing service's operator.

In another embodiment, the disclosure includes a computer implemented method for an online commerce and listing service comprising receiving a request for information about an item embedded in an agent website from an online user that selects the item on the agent website, retrieving, with a processor, the information about the item selected by the online user from a content aggregation repository, wherein the content aggregation repository comprises a plurality of items and wherein some of the plurality of items belong to different providers independent from the agent website, and sending the detailed information about the item selected by the online user to the agent website for display in a user interface on the agent website.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a cloud mall service system.

FIG. 2 is a schematic diagram of another embodiment of a cloud mall service system.

FIG. 3 is a schematic diagram of an embodiment of a cloud mall service shopping scheme.

FIG. 4 is a schematic diagram of an embodiment of a store owner access method.

FIG. 5 is a schematic diagram of another embodiment of a cloud mall shopping method.

FIG. 6 is a schematic diagram of an embodiment of a check out method.

FIG. 7 is a schematic diagram of an embodiment of a network unit.

FIG. 8 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a system and method for enabling different store owners and/or content or service providers to open or establish stores on top of an electronic mall service, e.g., an online or cloud mall service. The store owners and content/service providers may subscribe to the mall service, which may store product, service, or content information from the store owners and providers in a content aggregation repository and import such information from the content aggregation repository when needed. The content aggregation repository may act as a large marketplace for different product providers such as product stores and businesses, content providers including content distributors such as Google, eBay, NBC, etc., content makers such as game developers, service providers/distributors, or combinations thereof.

The products, services, or content information may be shown and viewed as items at different agent websites without using applications or specific code by the store owners and content/service providers, e.g., simply using standard text and/or images displayed on the agent websites. The agent web sites may be any website run and managed by agents or parties that may be independent of the store owners and content/service providers, such as personal websites, bloggers' websites, social media websites, etc. When consumers or web viewers are interested in items displayed on the agent websites, the consumers or viewers may click on the items to view more information and optionally a list of comparable items and may purchase any of the products or services/content associated with the items if they chose to do so. The items provided to the consumers or viewers may be linked to corresponding information that may be imported from the content aggregation repository and that belong to different store owners or providers from different regions, countries, or markets, e.g., all over the globe.

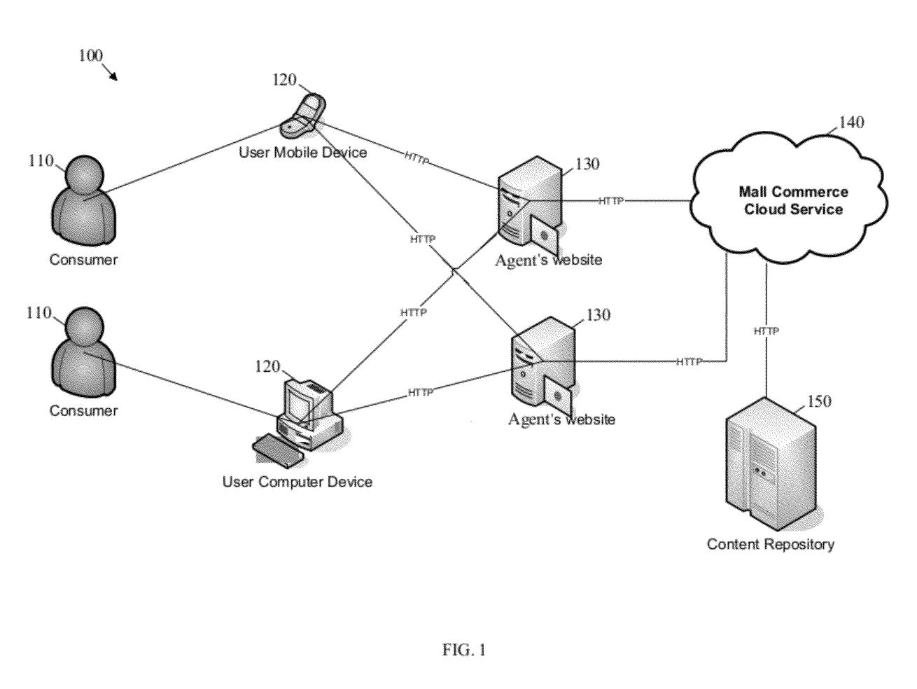

FIG. 1 illustrates an embodiment of a cloud mall service system 100. The cloud mall service system 100 may allow a plurality of store owners or businesses that sell products to market and sell their products to online users. The products may include any physical products, such as consumer goods, and/or electronic products, such as electronic books, games, or software. Additionally, the cloud mall service system 100 may provide a commerce and listing service that allows content and/or service providers or distributors to offer and sell their content and/or services to online users. Services may include any Internet or online based services, such as online banking, tax filing, credit checks, or other services. Content may include any deliverable electronic or digital content, such as video download, music download, or other media or non media content.

Specifically, the cloud mall service system 100 may be maintained in the cloud, e.g., accessible via the Internet, and provide integration of information on a plurality of products and/or services or content from different store owners and providers/distributors. The cloud mall service system 100 may also handle a plurality of mall service activities on behalf of the owners and providers/distributors, as described in more detail below. This may reduce individual cost for store owners and content and/or service providers or distributors for running individual websites or online stores and may provide the store owners and providers/distributors better marketing and access to online or Internet users. Additionally, the cloud mall service system 100 may provide revenue possibilities to agents associated with the websites that are accessed and used by the online users to purchase items.

The cloud mall service system 100 may comprise a plurality of online users or consumers 110, a plurality of devices 120, a plurality of agent websites 130, a cloud mall service 140, and a content repository 150. The components of the cloud mall service system 100 may be arranged as shown in FIG. 1. The consumers 110 may correspond to users or web shoppers/viewers that may be connected online, e.g., to the Internet, using the devices 120. The devices 120 may be any devices configured to provide access to the agent websites, for instance via Internet access.

For example, the user devices 120 may comprise mobile phones, personal digital assistants (PDAs), portable computers, and/or any other wireless devices. The user devices 120 may comprise infrared ports, Bluetooth interfaces, Institute of Electrical and Electronics Engineers (IEEE) 802.11 compliant wireless interfaces, and/or any other wireless communication systems that enable the user devices 120 to communicate wirelessly. Additionally or alternatively, the user devices 120 may communicate using fixed links, such as wired cables and/or fiber optic cables, to access the agent websites 130. The fixed link may implement Ethernet, Asynchronous Transfer Mode (ATM), Internet Protocol (IP), or any other suitable protocol. Such user devices 120 may be fixed devices, including personal computers (PCs) such as desktop computers, telephones such as voice over IP (VoIP) telephones, and/or set top boxes. In some embodiments, the user devices 120 may comprise portable devices, such as laptop computers or cordless phones, which may use fixed links to establish communications.

The agent websites 130 may be any websites or web applications, also referred to as apps, which allow the consumers 110 to view, read, type, interact, download, and/or upload content. The agent web sites may be provided and/or maintained by different agents, such as website owners, web or application developers, or web content providers. For instance, the agent websites 130 may comprise blogger websites, social media websites, shopping websites, personal websites, and/or other types of websites. The agent websites 130 may communicate with the devices 120 using links and networking protocols, such as Hypertext Transfer Protocol (HTTP). The agent websites 130 may display a plurality of items that may be of interest to the consumers 110, such as in text and/or media (video, sound, pictures, etc.) formats. The displayed items may be linked to products, content, and/or services available via the cloud mall service 140. The product, content, and/or services may be offered by different store owners, businesses, providers, distributors, etc., which may subscribe to the cloud mall service 140.

The agent websites 130 may communicate with the cloud mall service 140 using links and networking protocols, e.g., via HTTP. As such, the consumer 110 may view and then click on an item to obtain additional information, such as pricing and brand information, and/or to purchase the product, service, or content associated with that item. The items may be included as part of the displayed information on the agent websites 130, i.e., may be embedded in the websites with other website related content or information. The items may be linked in a relatively simple manner to the corresponding information at the cloud mall service 140, such as using hyperlinks. Specifically, the linked items may not require using dedicated code, programming, or software by the agents of the agent websites 130. This may allow any website owner or developer with basic website building skills to incorporate such item links in an agent website 130.

The cloud mall service 140 may be any system, application, and/or service configured to enable a plurality of store owners, content or service providers, or combinations thereof to sell or provide their products and services to the consumers 110. The cloud mall service 140 may comprise infrastructure and resources that provide the store owners and content/service providers or distributors access to the consumers 110 without the need for the store owners and providers/distributors to establish and maintain their own individual online stores or websites. This may save the store owners and providers/distributors cost for operating the websites including infrastructure cost. The store owners and providers/distributors may not need to store any item related information and may not need to provide the item information to the devices 120. Instead, the infrastructure and resources of the cloud mall service 140 may be used to provide all commerce related activities, such as product listing, promotion, product description, and transaction information, e.g., in real-time. The cloud mall service 140 may comprise a plurality of services, including an item listing service, a store owner management service, a user authentication service, a billing and transaction service, a promotion service, a searching service, a catalog service, a template service, or combinations thereof.

The cloud mall service's 140 resources may comprise computing resources, such as programs and applications, which are used to link product and service/content information to items at the agent websites 130. For instance, the computing resources may include any program or code configured to receive consumers' 110 requests for item information from the agent websites 130, send the information to the agent websites 130, receive consumers' 110 purchase requests from the agent websites 130. The computing resources may also be configured to handle all necessary purchasing transactions and product shipment, service delivery, or content download. The cloud mall service's 140 infrastructure may comprise hardware for running the resources, such as servers and/or virtual machines, which may be located in one data center or distributed across multiple data cents, e.g., via Internet connectivity.

The content repository 150 may be part of the cloud mall service's 140 resources and infrastructure or may be coupled to the cloud mall service 140. The content repository 150 may comprise one or more storage units for storing information about the different products, services, and content offered via the cloud mall service 140. The information may be an aggregation of different information from a plurality of subscribed store owners, content/service providers, content/service distributors, or combinations thereof.

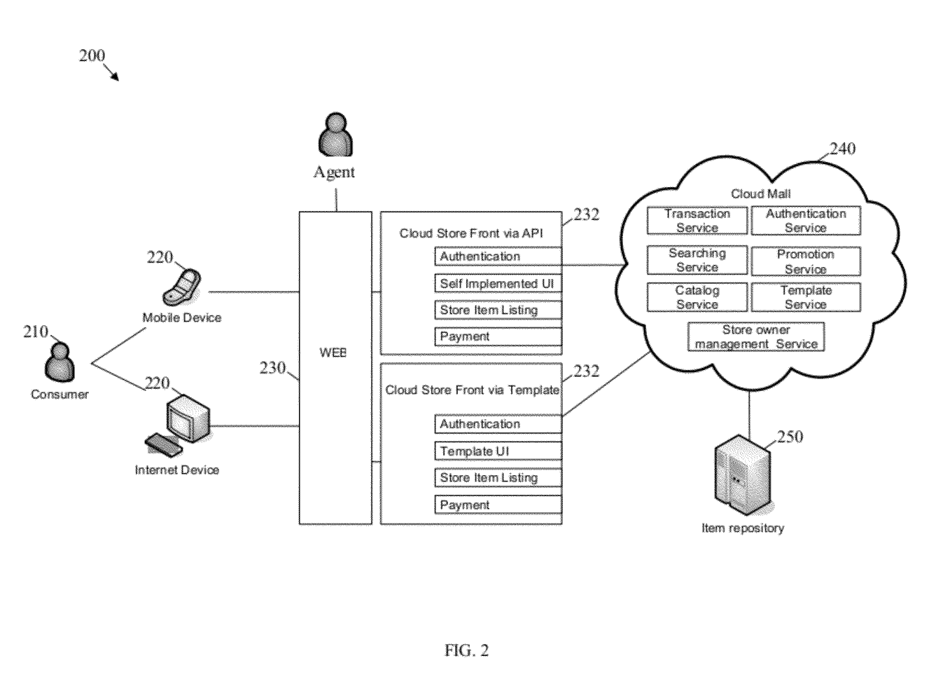

FIG. 2 illustrates another embodiment of a cloud mall service system 200 that may correspond to or may be similar to the cloud mall service system 100. The cloud mall service system 200 may allow a plurality of store owners or businesses and similarly service and content providers or distributors to market and sell their products and services to online users. The cloud mall service system 200 may comprise a plurality of online users or consumers 210, a plurality of devices 220, at least one agent website 230, one or more website interfaces 232, a cloud mall service 240, and a repository 250. The consumers 210, devices 220, agent website 230, cloud mall service 240, and repository 250 may be configured similar to the consumers 110, devices 120, agent website 130, cloud mall service 140, and content repository 150, respectively. The components of the cloud mall service system 200 may be arranged as shown in FIG. 2.

The website interfaces 232 may be any software or programming interfaces coupled to the agent website 230 and the cloud mall service 240 and configured to allow the agent website 230 to communicate and exchange information with the cloud mall service 240. The website interface 232 may be provided to the agent website 230 by the cloud mall service 140 to allow the agent website 230 to display product or service/content related information (on the devices 220) from the cloud mall service 240 or the repository 250, upon request of the consumers 210. The website interfaces 232 may also allow the consumers 210 to initiate purchase transactions if they request so and forward such request to the cloud mall service 240 to complete the transactions and deliver or initiate shipping of products/services/content. The website interfaces 232 may allow using simple text or picture formats to display or embed items on the agent website 230. The website interfaces 232 may operate in the background of the agent website 230 or at an instance corresponding to the agent website 230 that is maintained at the cloud mall service 240.

The consumer 210 may trigger the operation of the website interfaces 232 by clicking on the displayed or embedded items on the agent website 230. For instance, the website interface 232 may be an application programming interface (API) that provides a cloud store front on the agent website 230 and may be triggered when the consumer 210 clicks on a product or service/content related item (e.g., text or picture) on the agent website 230. The API may comprise an authentication module (e.g., code or program) that authenticates the agent website 230 and the consumer 210 request, and an implemented user interface (UI), for instance by the agent website 230 or its agent. The API may also comprise a store item listing function that stores a list of related items and information, and a payment module for initiating and verifying payment transactions. Alternatively, the website interface 232 may be a template that provides a cloud store front on the agent website 230, which may be triggered when the consumer 210 clicks on a product or service/content related item (e.g., text or picture) on the agent website 230. The template may comprise an authentication module, a template UI, a store item listing function, and a payment module.

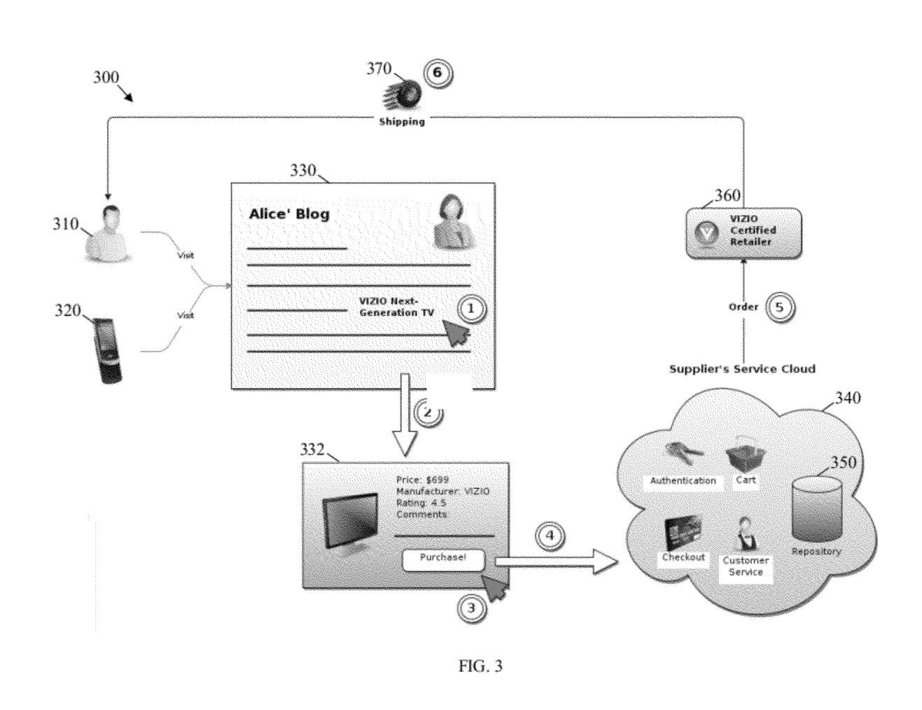

FIG. 3 illustrates an embodiment of a cloud mall service shopping scheme 300 that may be implemented in the cloud mall service system 100 and similarly the cloud mall service system 200. At step 1, an online user or consumer 310 may use a device 320 (e.g., a mobile smart phone) to access an agent website 330 (e.g., Alice blog website). The consumer 310 may surf the agent website 330 and view an embedded text or picture for an item or product (e.g., Vizio next-generation television (TV)). At step 2, the consumer 210 may click on the displayed item (the Vizio TV) and trigger a UI 332 that displays information about the item, e.g., pricing, manufacturer, and rating information. The UI 332 may be part of an API or a template running in the background of the agent website 330 or at a cloud mall service 340. The information displayed in the UI 332 may be obtained from a repository 350 at the cloud mall service 340.

At step 3, the consumer 310 may click on a purchase option in the UI 332. This may trigger the UI 332, at step 4, to interact with other related modules or function at the cloud mall service 340, such as for handling authentication, check out, customer service, shopping cart, and/or other purchase transaction related functions. As such, the consumer 310 may enter additional information for cash or credit card processing and shipping information. Some of the information needed to complete such transactions successfully may also be obtained from the repository 350. Such information may correspond to one or different parties involved in the purchase transactions, such as store owners (product seller), service providers (for cash transactions and shipping), distributors or suppliers (warehouses), etc. At step 5, the cloud mall service may send an order or request to a distributor or store owner 360 (e.g., Vizio certified retailer) for shipping the product to the consumer 310. The order or request may comprise information corresponding to the consumer 310, such as address information and delivery preference. At step 6, a shipping service may ship the purchased product 370 to the consumer's 310 address.

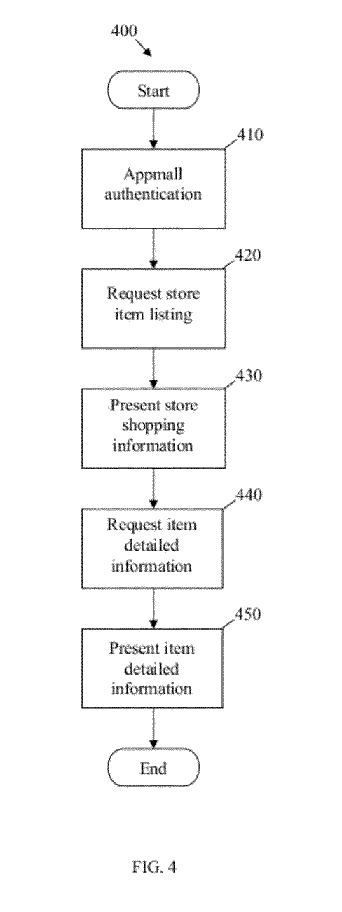

FIG. 4 illustrates an embodiment of a store owner access method 400. The method 400 may be used by a store owner or content/service provider or distributor to access the cloud mall service system 100 or the cloud mall service system 200 to provide an item (product, content, or service) or a list of items and related information to online users and thus may allow item purchasing. The store owner access scheme 400 may begin at block 410, where an application mall authentication may be established. The authentication process may provide a user or subscriber of the cloud mall service, e.g., a store owner, a security token that may be used trough the steps of the method 400 and expire when authentication is renewed or when the method 400 ends or an authentication predetermined period expires.

At block 420, the cloud mall service may request from the user or subscriber a store item listing that may be sent to the cloud mall service, such as for all or some store items offered by a store owner. At block 430, the user or subscriber may present store shopping information to the cloud mall service. For instance, the store owner may send a response for the item listing request that includes an array or list of items. The sent response or information may also include a set of item information for each item, which may comprise but is not limited to a short description of the item, the name of the item, the device(s) that support(s) the item, the price, the maker, etc. The item and item information may be presented to online users or consumers upon request.

At block 440, another user or consumer may request item detailed information. The request may be sent from an agent website of the user (i.e., the agent) or viewed by the user (i.e., the consumer), such as when the consumer clicks on, selects, or points to a text or picture for the item. At block 450, the cloud mall service may present item detailed information to the user or consumer. The method 400 may then end.

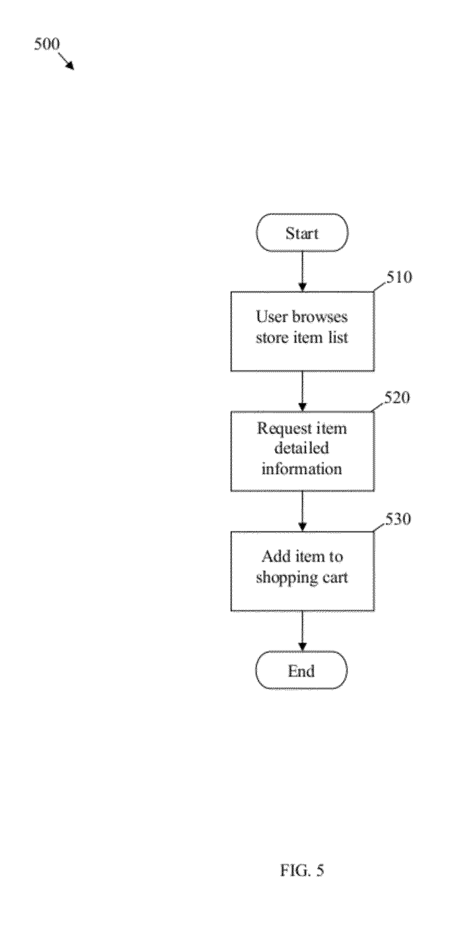

FIG. 5 illustrates an embodiment of a cloud mall shopping method 500, which may be used by an online user or consumer to surf agent websites and purchase products, services, or content via a cloud mall service. The cloud mall shopping method 500 may begin at block 510, where a user may browse a store item list. The store item list may be displayed to the user by clicking or selecting and item (in a text, picture, or other display format) on the agent website. At block 520, the user may request item detailed information. For instance, the user may click on an item in the item list to view item detailed information, e.g., price, maker, and/or other item related information. As such, the agent website may provide a UI or a window that shows more information about the item, which may include the option to buy or order the item. At block 530, the user may add the item to a shopping chart. The user's action may trigger the cloud mall service, e.g., via an API or template function, to add the selected item to a shopping cart instance for the user. The method 500 may then end. The user may subsequently check out and the item may be shipped or delivered (downloaded).

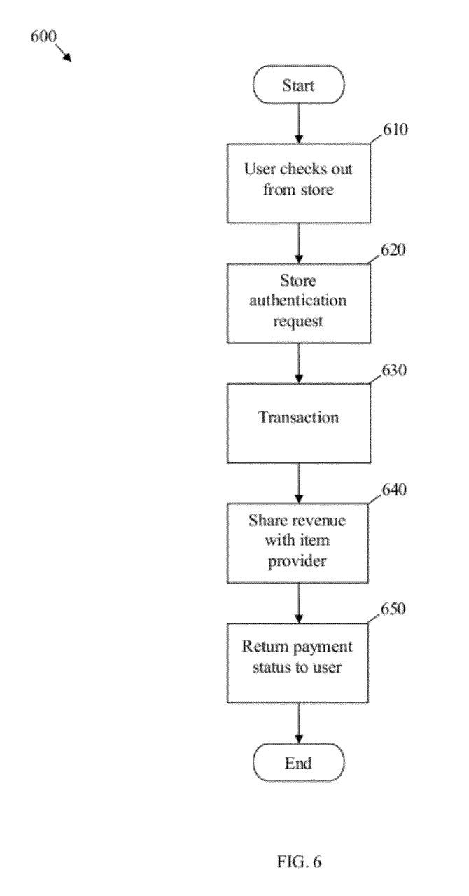

FIG. 6 illustrates an embodiment of a check out method 600, which may be used by an online user or consumer to check out after adding one or more items to a shopping card. The check out method 600 may begin at block 610, where a user may check out from an online store, such as at the agent website. The user may check out with one or more items that are selected by the user. At block 620, a store authentication request may be sent to the cloud mall service from the website and a transaction token associated with the transaction may also be sent or returned from the website to the cloud mall service. At block 630, a purchase transaction may be handled by the cloud mall service, using the necessary functions or modules as described above.

At block 640, the cloud mall service may share revenue (from the transaction) with the item provider, e.g., a store owner or a service/content provider or distributor. The cloud mall service may share income from the total purchase with the item provider. The cloud mall service may also share revenue with the agent website, e.g., if the agent website is not associated with the item provider. At block 650, the cloud mall service may return payment or transaction status to the user. This may include an electronic invoice or receipt of the purchase transaction, which may comprise pricing and shipping information and optionally other information about the item. The status may be displayed on the website and/or sent via an email provided by the user, e.g., during transaction. The method 600 may then end.

In some embodiments, the online user or consumer may access websites that may be shopping websites, which may be associated with the item providers (store owners) or third parties (agents). The shopping websites may display a plurality of items for products, services, or content that may be offered. Although the websites may be owned by item providers, such as store owners, the websites may still have website interfaces, such as the website interfaces 232. The website interfaces, such as APIs or templates, may be coupled to the cloud mall service and configured to allow the shopping websites to communicate and exchange information with the cloud mall service, as describe in the cloud mall service system 200. As such, the interfaces may offload a substantial amount of resources to complete transactions to the cloud mall service system and save the item providers some website operation cost.

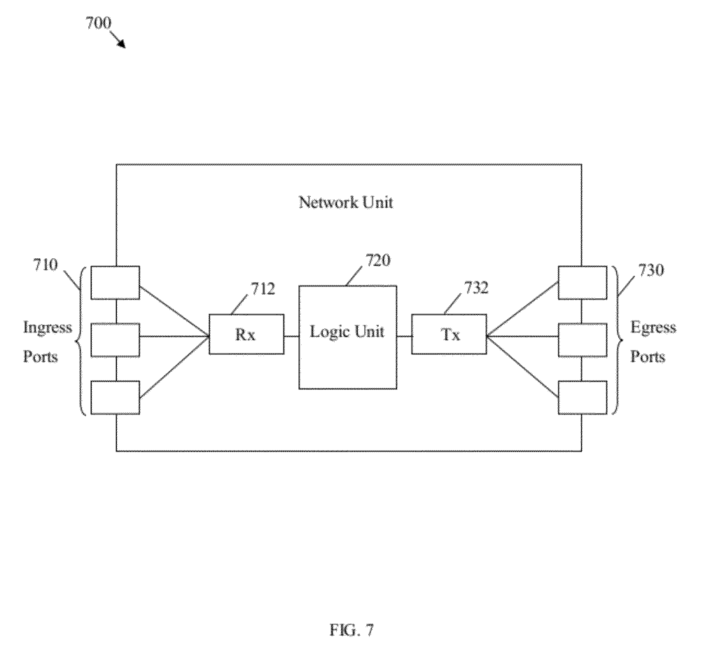

FIG. 7 illustrates an embodiment of a network unit 700, which may be any device that transports and processes data through a network, e.g., the cloud mall system 100 or 200. For instance, the network unit 700 may be part of the infrastructure of the cloud mall service 140 or 240, such as a server in a data center. The network unit 700 may comprise one or more ingress ports or units 710 coupled to a receiver (Rx) 712 for receiving packets, objects, or Type-Length-Values (TLVs) from other network components. The network unit 700 may comprise a processor or logic unit 720 to handle the requests and transactions described above. The logic unit 720 may implement or support the methods 400, 500, and 600 and thus handle the different communications and transactions with the websites, the item providers, and any other parties involved in the transactions. The logic unit 720 may be implemented using hardware, software, or both. The network unit 700 may also comprise one or more egress ports or units 730 coupled to a transmitter (Tx) 732 for transmitting packets or data to the other network components. The components of the network unit 700 may be arranged as shown in FIG. 7.

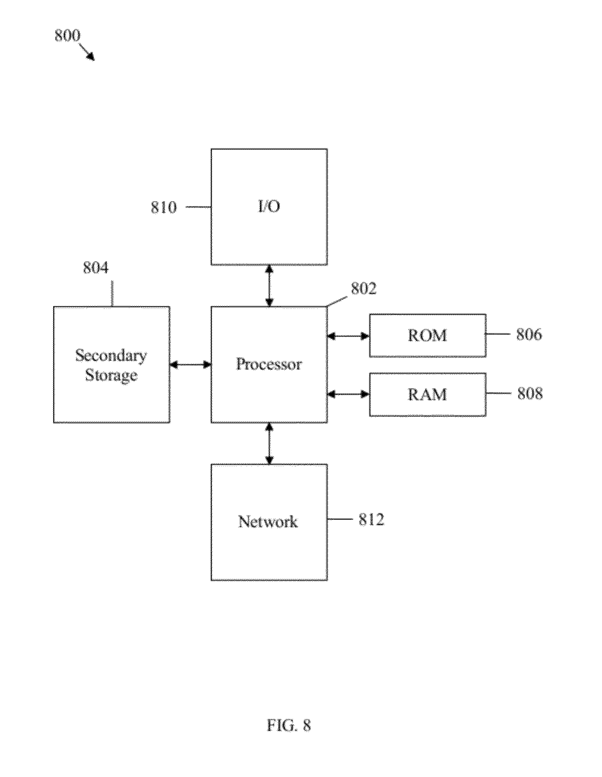

The network components described above may be implemented on any general-purpose network component, such as a computer or network component with sufficient processing power, memory resources, and network throughput capability to handle the necessary workload placed upon it. FIG. 8 illustrates a typical, general-purpose network component 800 suitable for implementing one or more embodiments of the components disclosed herein. The network component 800 includes a processor 802 (which may be referred to as a central processor unit or CPU) that is in communication with memory devices including secondary storage 804, read only memory (ROM) 806, random access memory (RAM) 808, input/output (I/O) devices 810, and network connectivity devices 812. The processor 802 may be implemented as one or more CPU chips, or may be part of one or more application specific integrated circuits (ASICs).

The secondary storage 804 is typically comprised of one or more disk drives or tape drives and is used for non-volatile storage of data and as an over-flow data storage device if RAM 808 is not large enough to hold all working data. Secondary storage 804 may be used to store programs that are loaded into RAM 808 when such programs are selected for execution. The ROM 806 is used to store instructions and perhaps data that are read during program execution. ROM 806 is a non-volatile memory device that typically has a small memory capacity relative to the larger memory capacity of secondary storage 804. The RAM 808 is used to store volatile data and perhaps to store instructions. Access to both ROM 806 and RAM 808 is typically faster than to secondary storage 804.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A cloud based service system for providing an online commerce and listing service comprising:
a cloud component configured to support the online commerce and listing service for a plurality of item providers and communicate with a plurality of subscriber websites accessible by a plurality of online user devices;
a repository coupled to the cloud component and configured to store information for a plurality of items provided by the item providers; and
an agent component for websites who subscribe to the online commerce and listing service, wherein the agent component is configured to match and embed an item description and shopping information to content of at least one of the subscriber websites.

2. The cloud based service system of claim 1, wherein the online commerce and listing service is a service that allows at least one of a plurality of subscribed store owners, content providers, and service providers to store at least one of product, service, and content information in a content aggregation repository and import the at least one of product, service, and content information from the content aggregation repository when needed.

3. The cloud based service system of claim 1, wherein the item providers are different from the subscriber websites' owners and from the online commerce and listing service's operator.

4. The cloud based service system of claim 1, wherein the item providers comprise a product distributor and wherein the agent component is configured to display the item description when a user selects an embedded link in the content.

5. The cloud based service system of claim 1, wherein the user devices comprise at least one of a mobile device and a computing device.

6. The cloud based service system of claim 1, wherein the online commerce and listing service comprises at least one of an item listing service, a user authentication service, a billing and transaction service, a promotion service, a searching service, a catalog service, and a template service.

7. The cloud based service system of claim 1, wherein the websites are accessible by the online user devices and similarly the cloud component is accessible by the websites via the Internet.

8. A network component for operating an online commerce and listing service comprising:
a receiver configured to receive a request from a website accessed on a device of a consumer for obtaining information about an embedded item on the website;
a repository configured to store the information about the item from an item provider;
a logic unit configured to fetch the information about the embedded item on the website from the repository; and
a transmitter configured to send the information about the embedded item to the website,
wherein the item provider is different from the website' owner and from the online commerce and listing service's operator.

9. The network component of claim 8, wherein the website is independent from the item provider.

10. The network component of claim 8, wherein the embedded item is displayed on the website in at least one of a text format and a picture format without using code specific to the website' owner and the item provider.

11. The network component of claim 8, wherein the information about the embedded item comprises at least one of pricing, manufacturer, and rating information.

12. The network component of claim 8, wherein the information about the embedded item sent to the website comprises information about a list of items comparable to the embedded item and that belong to the same or different item providers.

13. The network component of claim 8, wherein the receiver is further configured to receive a purchase request from the website for an embedded item selected by the consumer, wherein the logic unit processes the purchase request by interacting with one or more modules of the cloud mall service to complete a purchase transaction, and wherein the transmitter sends information about the purchase transaction to a provider of the embedded item.

14. The network component of claim 13, wherein the modules of the cloud mall service handle at least one of authentication, check out, customer service, and a shopping cart.

15. The network component of claim 13, wherein the purchase request comprises at least one of cash or credit card information, shipping or mailing information, and emailing information.

16. The network component of claim 13, wherein income from the purchase transaction is shared between the cloud mall service, the provider of the embedded item, and an owner of the website.

17. A computer implemented method for an online commerce and listing service comprising:
receiving a request for information about an item embedded in an agent website from an online user that selects the item on the agent website;
retrieving, with a processor, the information about the item selected by the online user from a content aggregation repository, wherein the content aggregation repository comprises a plurality of items and wherein some of the plurality of items belong to different providers independent from the agent website; and
sending the detailed information about the item selected by the online user to the agent website for display in a user interface on the agent website.

18. The computer implemented method of claim 17 further comprising:
completing a purchase transaction if the online user selects to order the item after receiving the detailed information.

19. The computer implemented method of claim 18 further comprising:
adding the item to a shopping cart instance for the online user if the online user selects to order the item after receiving the detailed information; and
completing the purchase transaction if the online user selects to check out.

20. The computer implemented method of claim 18 further comprising receiving a store authentication request from the agent website and a transaction token associated with the purchase transaction.

21. The computer implemented method of claim 18 further comprising receiving a store authentication request from the agent website and a transaction token associated with the purchase transaction.

22. The computer implemented method of claim 18 further comprising:
sharing revenue from the purchase transaction between the cloud mall service and a provider of the item; and
returning payment status to the user.

23. The computer implemented method of claim 17, wherein the agent website provides a service that is different from a shopping service.
